(19) United States
(12) Patent Application Publication
(10) Pub. No.: US 2025/0219263 A1
(43) Pub. Date: Jul. 3, 2025

(54) NONAQUEOUS ELECTROLYTE BATTERY

(71) Applicant: HONDA MOTOR CO., LTD., Tokyo (JP)

(72) Inventors: Takuya TANIUCHI, Saitama (JP); Kizashi IWAKIRI, Saitama (JP); Yoshihiko NAKAJIMA, Saitama (JP)

(21) Appl. No.: 19/001,565

(22) Filed: Dec. 26, 2024

(30) Foreign Application Priority Data
Dec. 28, 2023 (JP) 2023-223127

(51) Int. Cl. H01M 50/54; H01M 10/0585; H01M 50/105; H01M 50/178; H01M 50/474

(52) U.S. Cl. CPC H01M 50/54; H01M 10/0585; H01M 50/105; H01M 50/178; H01M 50/474

(57) ABSTRACT

To provide a nonaqueous electrolyte battery capable of suppressing breakage of tabs even when an electrode stack constituting the nonaqueous electrolyte battery expands due to charge and discharge. Each tab is divided into a part to which tension is applied at the time of volume expansion of an electrode stack and a part where tabs converge (electrical connection part with the outside), and the tension applied to the part of each tab where the tabs converge is made equal. Specifically, a tab fixing member is disposed between negative electrode tabs and/or between positive electrode tabs, thereby suppressing an increase in tension between the tab fixing member and a negative electrode tab convergence part and/or a positive electrode tab convergence part.

This application is based on and claims the benefit of priority from Japanese Patent Application No. 2023-223127, filed on 28 Dec. 2023, the content of which is incorporated herein by reference.

### BACKGROUND OF THE INVENTION

### Field of the Invention

The present invention relates to a nonaqueous electrolyte battery.

### Related Art

In recent years, research and development has been conducted on secondary batteries that contribute to energy efficiency in order to ensure that many people have access to affordable, reliable, sustainable, and advanced energy.

A secondary battery includes, for example, an electrode stack in which a plurality of positive electrodes and a plurality of negative electrodes are stacked via an electrolyte, and a packaging material that houses the electrode stack, and includes a positive electrode tab lead and a negative electrode tab lead that protrude from the packaging material. Positive electrode tabs extending from a plurality of positive electrodes converge and are connected to the positive electrode tab lead, and negative electrode tabs extending from a plurality of negative electrodes converge and are connected to the negative electrode tab lead.

Here, the positive electrode tab lead and the negative electrode tab lead are generally disposed substantially at the center with respect to the thickness of the electrode stack in the stacking direction. Therefore, the length of the tab from the electrode plate to the tab lead is different for each electrode plate.

FIG. 5 is a cross-sectional view showing the configuration of a conventional nonaqueous electrolyte battery. A nonaqueous electrolyte battery 10 shown in FIG. 5 includes an electrode stack 11, a packaging material 12 housing the electrode stack 11, and a positive electrode tab lead 17 and a negative electrode tab lead 14 protruding from the packaging material 12. A positive electrode tab convergence part 16a, which is formed by converging positive electrode tabs 16 extending from a plurality of positive electrodes, is connected to the positive electrode tab lead 17. A negative electrode tab convergence part 13a, which is formed by converging negative electrode tabs 13 extending from a plurality of negative electrodes, is connected to the negative electrode tab lead 14.

In the nonaqueous electrolyte battery 10 shown in FIG. 5, the positive electrode tab lead 17 and the negative electrode tab lead 14 protruding from the packaging material 12 are disposed so as to protrude in opposite directions at both end parts of the electrode stack 11 in a direction perpendicular to the stacking direction. A plurality of positive electrodes are connected to the positive electrode tab lead 17 via a plurality of positive electrode tabs 16, and a plurality of negative electrodes are connected to the negative electrode tab lead 14 via a plurality of negative electrode tabs 13.

Here, the nonaqueous electrolyte battery expands and contracts with charge and discharge, and the thickness of the electrode stack increases with charge. When the thickness of the electrode stack increases, the tensions of the tabs constituting the nonaqueous electrolyte battery differ from each other.

Specifically, when the volume of the electrode stack expands, a larger tension is applied to the tabs extending from the vicinity of the uppermost surface and the vicinity of the lowermost surface of the stack than to the tabs extending from the vicinity of the central part. Therefore, the tabs extending from the vicinity of the uppermost surface and the vicinity of the lowermost surface of the stack may be broken (foil breakage). In particular, in the case of a battery having a large expansion amount or a hard battery, the tension applied to the tab is likely to increase. Even if breakage of the tab (foil breakage) does not occur, the electrode plate in the vicinity of the tab may be damaged, which may lead to a short circuit or a decrease in performance of the nonaqueous electrolyte battery.

In response to this, Japanese Unexamined Patent Application, Publication No. 2022-70663 proposes that the “difference between the maximum and minimum electrical resistance values of a part from the electrode to the assembly part” of each tab be set to a threshold or less in order to suppress non-uniform expansion of an all-solid-state battery that uses lithium metal as the negative electrode. As a method of setting the resistance difference to a threshold or less, it is disclosed that the tabs are formed of the same material and the lengths of the tabs are equal to each other.

However, in the method disclosed in Japanese Unexamined Patent Application, Publication No. 2022-70663, the tabs are bent in order to align the lengths of the tabs and suppress non-uniform expansion of the battery, and the bends in the tabs suppress breakage of the tabs due to the force in the pulling direction. Therefore, the tension of each tab itself is not controlled.
Patent Document 1: Japanese Unexamined Patent Application, Publication No. 2022-70663

### SUMMARY OF THE INVENTION

An object of the present invention is to provide a nonaqueous electrolyte battery capable of suppressing breakage of tabs even when an electrode stack constituting the nonaqueous electrolyte battery expands due to charge and discharge.

To achieve the above object, the inventors have conducted extensive studies. The inventors have focused on the tension applied to tab wires extending from respective electrode plates constituting an electrode stack, and have considered that breakage of the tab wires could be suppressed by equalizing the tension. The inventors have found that if each tab is divided into a part to which tension is applied when the volume of the electrode stack expands and a part where the tabs converge (electrical connection part with the outside), the tension applied to the part of each tab where the tabs converge can be kept equal even when the volume of the electrode stack expands, and as a result, breakage of the tabs can be suppressed, and have completed the present invention.

That is, the present invention includes the following aspects.

[1]

A first aspect of the present invention is a nonaqueous electrolyte battery including: a packaging material; and an electrode stack housed in the packaging material, the electrode stack including a plurality of positive electrodes and a plurality of negative electrodes stacked via an electrolyte. The nonaqueous electrolyte battery further includes a positive electrode tab lead and a negative electrode tab lead protruding from the packaging material. A plurality of positive electrode tabs extend from the positive electrodes. End parts of the plurality of positive electrode tabs converge to form a positive electrode tab convergence part. The positive electrode tab convergence part is connected to the positive electrode tab lead. A plurality of negative electrode tabs extend from the negative electrodes. End parts of the plurality of negative electrode tabs converge to form a negative electrode tab convergence part. The negative electrode tab convergence part is connected to the negative electrode tab lead. A tab fixing member for fixing tabs is disposed between at least one pair of the negative electrode tabs adjacent to each other and/or between at least one pair of the positive electrode tabs adjacent to each other.

[2]

In a second aspect of the nonaqueous electrolyte battery according to the first aspect, a plurality of the tab fixing members are arranged side by side in a plane direction of the electrode stack.

[3]

In a third aspect of the nonaqueous electrolyte battery according to the first aspect, the tab fixing member is disposed between the negative electrode tabs at each end of the electrode stack in a stacking direction and/or between the positive electrode tabs at each end of the electrode stack in the stacking direction.

[4]

In a fourth aspect of the nonaqueous electrolyte battery according to the first aspect, the tab fixing member is disposed between all of the negative electrode tabs adjacent to each other and/or between all of the positive electrode tabs adjacent to each other.

[5]

In a fifth aspect of the nonaqueous electrolyte battery according to the first aspect, the tab fixing member is further disposed between a negative electrode tab and the packaging material at at least one of both ends of the electrode stack in a stacking direction and/or between a positive electrode tab and the packaging material at at least one of both ends of the electrode stack in the stacking direction.

[6]

In a sixth aspect of the nonaqueous electrolyte battery according to the first aspect, the tab fixing member is an insulator.

[7]

In a seventh aspect of the nonaqueous electrolyte battery according to the first aspect, the tab fixing member is frictionally fixed to the negative electrode tabs and/or the positive electrode tabs.

[8]

In an eighth aspect of the nonaqueous electrolyte battery according to the first aspect, the tab fixing member has a curved surface facing and contacting a negative electrode tab and/or a positive electrode tab.

[9]

In a ninth aspect of the nonaqueous electrolyte battery according to the first aspect, the negative electrode is a lithium metal negative electrode or a silicon negative electrode. The tab fixing member is disposed between at least one pair of the negative electrode tabs adjacent to each other. [10]

In a tenth aspect of the nonaqueous electrolyte battery according to the first aspect, the nonaqueous electrolyte battery is a solid-state battery.

According to the present invention, it is possible to provide a nonaqueous electrolyte battery capable of suppressing breakage of tabs even when an electrode stack constituting the nonaqueous electrolyte battery expands due to charge and discharge.

### BRIEF DESCRIPTION OF THE DRAWINGS

FIG. 1 is a cross-sectional view of a negative electrode tab lead-side end part of a nonaqueous electrolyte battery according to an embodiment of the present invention;

FIG. 2 is a cross-sectional view of a negative electrode tab lead-side end part of a nonaqueous electrolyte battery according to a modification of the embodiment;

FIG. 3 is a cross-sectional view of a negative electrode tab lead-side end part of a nonaqueous electrolyte battery according to a modification of the embodiment;

FIG. 4 is a cross-sectional view of a negative electrode tab lead-side end part of a nonaqueous electrolyte battery according to a modification of the embodiment; and

FIG. 5 is a cross-sectional view showing the configuration of a conventional nonaqueous electrolyte battery.

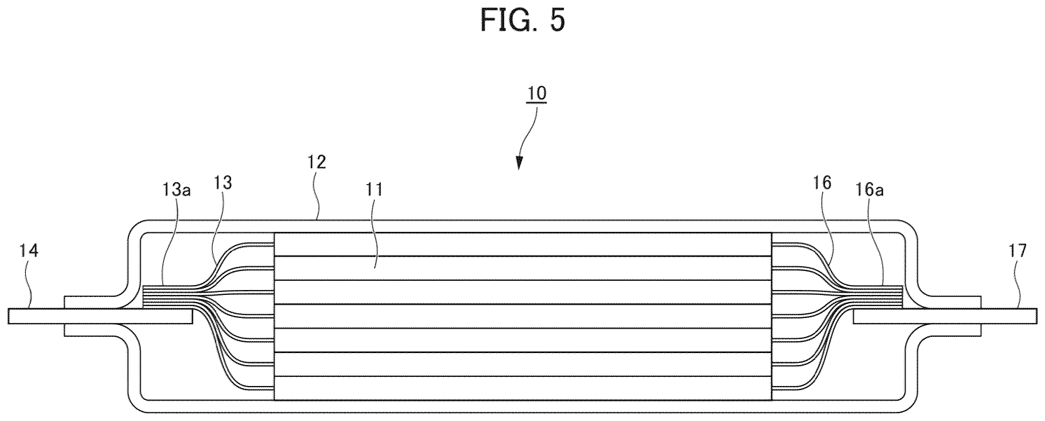

Hereinafter, embodiments of the present invention will be described with reference to the drawings.

### DETAILED DESCRIPTION OF THE INVENTION

### Nonaqueous Electrolyte Battery

A nonaqueous electrolyte battery according to the present disclosure includes a packaging material, and an electrode stack housed in the packaging material, the electrode stack including a plurality of positive electrodes and a plurality of negative electrodes stacked via an electrolyte. The nonaqueous electrolyte battery of the present disclosure includes a positive electrode tab lead and a negative electrode tab lead protruding from the packaging material.

In the nonaqueous electrolyte battery of the present disclosure, a positive electrode tab extends from a positive electrode, end parts of a plurality of positive electrode tabs converge to form a positive electrode tab convergence part, and the positive electrode tab convergence part is connected to the positive electrode tab lead. A negative electrode tab extends from a negative electrode, end parts of a plurality of negative electrode tabs converge to form a negative electrode tab convergence part, and the negative electrode tab convergence part is connected to the negative electrode tab lead.

In the nonaqueous electrolyte battery of the present disclosure, a tab fixing member is disposed between at least one pair of adjacent negative electrode tabs and/or between at least one pair of adjacent positive electrode tabs. By disposing the tab fixing member between the negative electrode tabs and/or between the positive electrode tabs, it is possible to suppress an increase in tension between the tab fixing member and the negative electrode tab convergence part and/or the positive electrode tab convergence part disposed. As a result, it is possible to keep the tension applied to the part of each tab where the tabs converge equal, and to suppress breakage of the tabs when the volume of the electrode stack expands.

### [Type of Nonaqueous Electrolyte Battery]

The type of the nonaqueous electrolyte battery of the present disclosure is not limited. The nonaqueous electrolyte battery of the present disclosure may be, for example, a solid-state battery cell such as an all-solid-state lithium ion battery cell or an all-solid-state lithium metal battery cell, or a nonaqueous electrolytic solution battery cell such as a lithium metal battery cell. Among these, a solid-state battery cell is preferable.

### [Packaging Material]

In the nonaqueous electrolyte battery of the present disclosure, any packaging material known in the field of nonaqueous electrolyte batteries can be applied as the packaging material. Examples of such a packaging material include a metal and a film in which a resin layer is formed on the surface of a metal layer. Examples of the metal constituting the metal layer include aluminum. Examples of the resin constituting the resin layer include polyethylene, polyvinyl fluoride, and polyvinylidene chloride.

### [Electrode Stack]

In the nonaqueous electrolyte battery of the present disclosure, the electrode stack is a stack in which a plurality of positive electrodes and a plurality of negative electrodes are stacked via an electrolyte, and is housed in a packaging material.

### (Positive Electrode)

In the nonaqueous electrolyte battery of the present disclosure, the positive electrode constituting the electrode stack is not limited, and any known positive electrode in the field of nonaqueous electrolyte batteries can be used. For example, when the nonaqueous electrolyte battery of the present disclosure is an all-solid-state lithium metal battery, the positive electrode has a stacked structure of a positive electrode current collector and a positive electrode material mixture layer, and the positive electrode material mixture layer is disposed adjacent to an electrolyte layer.

When the nonaqueous electrolyte battery of the present disclosure is an all-solid-state lithium metal battery, the positive electrode current collector is not limited, and examples thereof include aluminum foil. The positive electrode material mixture layer contains a positive electrode active material as an essential component, and may optionally contain a solid electrolyte, a conductivity aid, a binder, and the like.

The positive electrode active material is not limited as long as it can occlude and release lithium ions. Examples of the positive electrode active material include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

### (Negative Electrode)

In the nonaqueous electrolyte battery of the present disclosure, the negative electrode constituting the electrode stack is not limited, and any known negative electrode in the field of nonaqueous electrolyte batteries can be used. For example, when the nonaqueous electrolyte battery of the present disclosure is an all-solid-state lithium metal battery, the negative electrode has a stacked structure of a lithium metal layer and a negative electrode current collector, and the lithium metal layer is disposed adjacent to an electrolyte layer. Alternatively, an intermediate layer may be disposed between the lithium metal layer and the electrolyte layer to uniformize the dissolution and deposition of lithium.

When the nonaqueous electrolyte battery of the present disclosure is an all-solid-state lithium metal battery, the negative electrode current collector is not limited, and examples thereof include copper foil.

### (Electrolyte)

In the nonaqueous electrolyte battery of the present disclosure, the electrolyte constituting the electrode stack is not limited, and any known electrolyte in the field of nonaqueous electrolyte batteries can be used. Examples of the electrolyte include an electrolytic solution and a solid electrolyte. When an electrolytic solution is used, the electrolytic solution is held in a separator and disposed. For example, when the nonaqueous electrolyte battery of the present disclosure is an all-solid-state lithium metal battery, the electrolyte disposed between the positive electrode and the negative electrode is disposed between the positive electrode material mixture layer and the lithium metal layer.

When the nonaqueous electrolyte battery of the present disclosure is an all-solid-state lithium metal battery, the electrolyte is a solid electrolyte layer. The solid electrolyte constituting the solid electrolyte layer is not limited as long as it is a material capable of conducting lithium ions. Examples of the solid electrolyte include an oxide electrolyte and a sulfide electrolyte.

### [Positive Electrode Tab Lead and Negative Electrode Tab Lead]

In the nonaqueous electrolyte battery of the present disclosure, the positive electrode tab lead and the negative electrode tab lead protrude from the packaging material.

### (Disposition of Positive Electrode Tab Lead and Negative Electrode Tab Lead)

In the nonaqueous electrolyte battery of the present disclosure, the protruding directions of the positive electrode tab lead and the negative electrode tab lead protruding from the packaging material are not limited. The protruding directions of the positive electrode tab lead and the negative electrode tab lead may be opposite to each other, may be the same direction, or may be oblique directions. The protruding directions of the positive electrode tab lead and the negative electrode tab lead can be selected as appropriate depending on the use environment of the nonaqueous electrolyte battery of the present disclosure and the configuration of a module formed from a plurality of the nonaqueous electrolyte batteries.

### (Number of Positive Electrode Tab Leads and Negative Electrode Tab Leads)

The nonaqueous electrolyte battery of the present disclosure may be a single battery in which a positive electrode tab lead and a negative electrode tab lead are respectively connected to all positive electrodes and all negative electrodes constituting an electrode stack. Alternatively, the nonaqueous electrolyte battery of the present disclosure may be an assembled battery in which a stack unit in which positive electrodes, electrolyte layers, and negative electrodes are stacked is divided into several sub-stacks, and a positive electrode tab lead and a negative electrode tab lead are connected to each sub-stack. When the nonaqueous electrolyte battery of the present disclosure is a single battery, the number of positive electrode tab leads and the number of negative electrode tab leads are each one. When the nonaqueous electrolyte battery of the present disclosure is an assembled battery, the number of positive electrode tab leads and the number of negative electrode tab leads are each plural.

### [Tab Fixing Member]

In the nonaqueous electrolyte battery of the present disclosure, the tab fixing member is disposed between at least one pair of the adjacent negative electrode tabs and/or at least one pair of the adjacent positive electrode tabs. The tab fixing member exhibits a function of suppressing the movement of the tabs. The tab can be divided into the part to which tension is applied when the volume of the electrode stack expands, and the part where the tabs converge (the connection part with the tab lead), centering on the tab fixing member. By suppressing the movement of the tabs by the tab fixing member, even when the volume of the electrode stack expands, it is possible to suppress an increase in tension due to pulling of the part of each tab where the tabs converge (the connection part with the tab lead), and therefore, it is possible to keep the tension of each tab equal and to suppress breakage of the tabs.

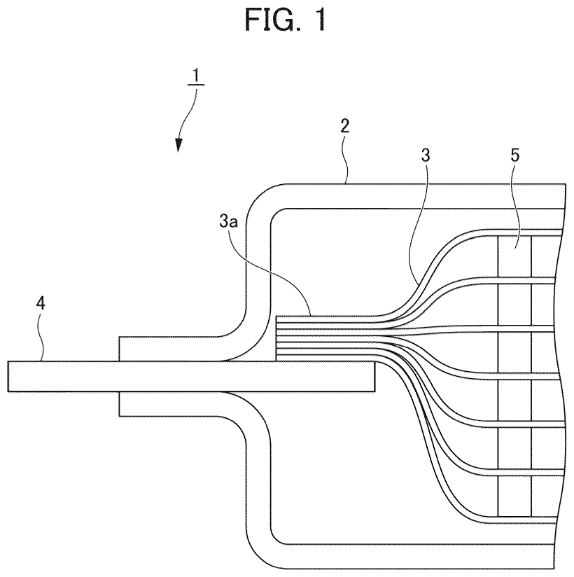

FIG. 1 is a cross-sectional view of an end part of a negative electrode tab lead 4 side of a nonaqueous electrolyte battery 1 according to an embodiment of the present invention. The nonaqueous electrolyte battery 1 shown in FIG. 1 is a battery in which an electrode stack (not shown) is housed in a packaging material 2, and a tab fixing member 5 is disposed between all adjacent negative electrode tabs 3. In the nonaqueous electrolyte battery 1, the tab fixing member 5 is disposed between a negative electrode tab convergence part 3a connected to the negative electrode tab lead 4 and an electrode stack (not shown).

### (Shape of Tab Fixing Member)

In the nonaqueous electrolyte battery 1 shown in FIG. 1, each of the tab fixing members 5 that are a plurality of individual materials, has a substantially rectangular parallelepiped shape, but the shape is not limited as long as it can suppress the movement of the tabs. As will be described later, the tab fixing member may have a curved surface facing and contacting the tab. Alternatively, for example, a single material having a length equal to the length of the electrode stack in the thickness direction may be used, or a plurality of individual materials disposed between adjacent tabs may be used. In the case of a single material, for example, a plurality of recesses are provided, the tabs are arranged so that the tabs pass through the recesses, and the tab fixing member is sandwiched between the upper surface and the lower surface of the packaging material in the thickness direction of the electrode stack, whereby the tab fixing member can be fixed in the packaging material.

In the nonaqueous electrolyte battery 1 shown in FIG. 1, the tab fixing members 5 are a plurality of individual materials, and the individual tab fixing members 5 are disposed between the adjacent negative electrode tabs.

### (Disposition Location of Tab Fixing Member)

The disposition location of the tab fixing member is not limited as long as it is between at least one pair of the adjacent negative electrode tabs and/or between at least one pair of the adjacent positive electrode tabs. By disposing the tab fixing member in a part close to the part where the tabs converge (the connection part with the tab lead), the lengths of the tabs can be shortened and the size of the battery can be reduced, which can contribute to the energy density of the obtained nonaqueous electrolyte battery.

In general, in a nonaqueous electrolyte battery, expansion of a negative electrode is larger than that of a positive electrode. Therefore, by disposing the tab fixing member at least between the negative electrode tabs, the effect of the present invention can be further obtained.

When a plurality of individual tab fixing members are disposed between adjacent tabs, the tab fixing members may be disposed so that the distances from the part where the tabs converge (the connection part with the tab lead) to the tab fixing members become constant. If the plurality of tab fixing members are disposed so that the distances from the part where the tabs converge (the connection part with the tab lead) to the tab fixing members become constant, the size of the battery can be further reduced, which can contribute to the energy density of the obtained battery.

### (Material of Tab Fixing Member)

The material of the tab fixing member is not limited. I It may be an insulator or a conductor, but is preferably an insulator. When the tab fixing member is formed of an insulator, it is possible to prevent reflux between stacked layers in the event of an abnormality in the stacking step of the electrode stack (the step before tab convergence), making it easier to ensure process safety.

### (Disposition Method of Tab Fixing Member)

The method of disposing the tab fixing member to the negative electrode tabs and/or the positive electrode tabs is not limited as long as the tab fixing member can be disposed. As the method of disposing the tab fixing member to the negative electrode tabs and/or the positive electrode tabs, for example, fusing or welding to the tabs or friction fixing to the tabs can be used. Among them, friction fixing is preferable, and in the case of friction fixing, by controlling the friction coefficient of the tab fixing member, the tab fixing member can be fixed to the tabs only by the load at the time of tab convergence.

The tab fixing member may be disposed at the same time as the positive electrode material mixture or the like is applied to the current collector, or may be disposed in any subsequent step.

### (Contact Surface of Tab Fixing Member With Tab)

The shape of the contact surface of the tab fixing member with the tab, that is, the shape of the surface of the tab fixing member that is substantially perpendicular to the stacking direction of the electrode stack and faces the tab is not limited. The contact surface of the tab fixing member with the tab may be, for example, a flat surface, a curved surface, or a stepped surface having a step.

In particular, it is preferable that the contact surface of the tab fixing member with the tab, that is, the surface that faces and contacts the tab is a curved surface. By making the surface of the tab fixing member facing the tab a curved surface, the contact area between the tab and the tab fixing member increases, increasing the frictional force and enabling the fixing force for fixing the tab to be increased.

When the contact surface of the tab fixing member with the tab is a curved surface, the entire shape of the tab fixing member may have a gentle curve, or the corners of the tab fixing member may be chamfered to have a rounded shape. When the entire shape of the tab fixing member has a gentle curve, the cross-sectional shape of the tab fixing member may be an elliptical shape, for example.

Although the embodiment of the present invention has been described above, the present invention is not limited to the above-described embodiment, and the above-described embodiment may be modified within the scope of the gist of the present invention.

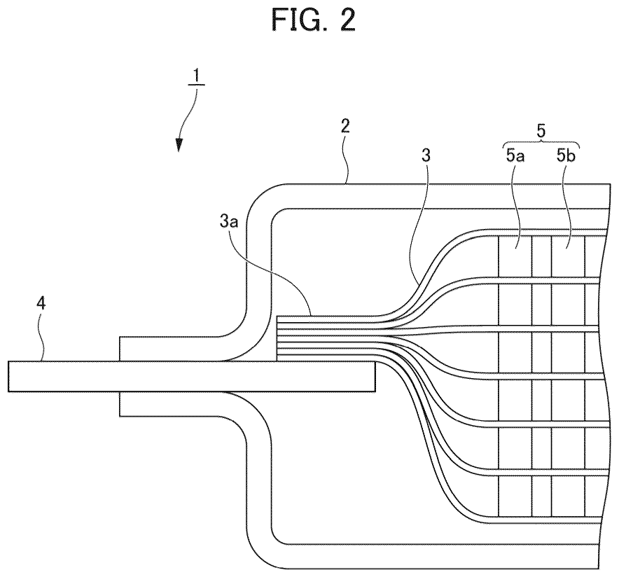

For example, FIGS. 2 to 4 are each a cross-sectional view of a negative electrode tab lead-side end part of a nonaqueous electrolyte battery according to a modification of the above-described embodiment. In the modification shown in FIG. 2, a plurality of tab fixing members 5a and 5b are arranged side by side in the plane direction of the electrode stack 11, as the tab fixing member 5. As described above, a plurality of tab fixing members may be arranged side by side in the plane direction of the electrode stack between at least one pair of the tabs.

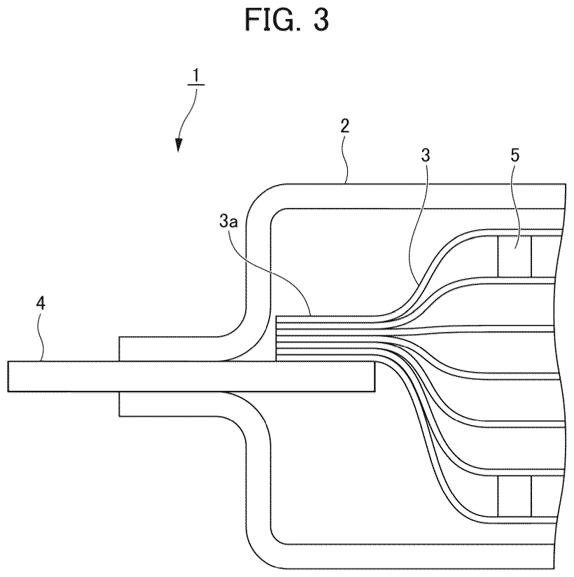

In the modification shown in FIG. 3, the tab fixing member 5 is disposed between the negative electrode tabs 3 at each end of the electrode stack 11 in the stacking direction. As described above, the tab fixing member 5 may be disposed between the negative electrode tabs and/or between the positive electrode tabs at each end of the electrode stack in the stacking direction.

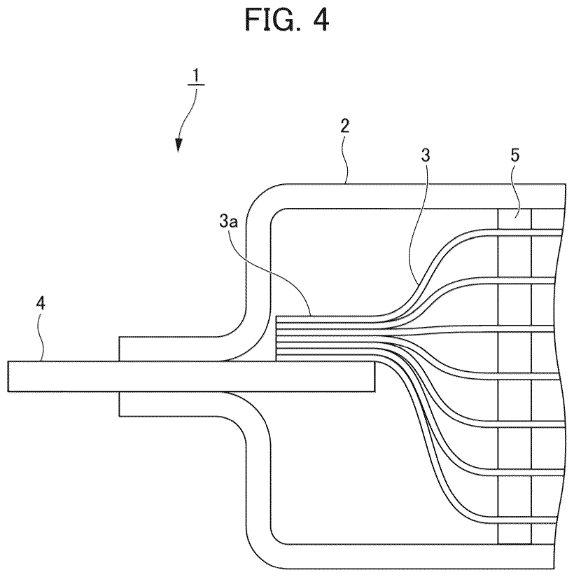

In the modification shown in FIG. 4, the tab fixing member 5 is disposed not only between all the negative electrode tabs 3 but also between the negative electrode tab 3 and the packaging material 2 at both ends of the electrode stack 11 in the stacking direction. As described above, the tab fixing member may be further disposed between the negative electrode tab and the packaging material at at least one of both ends of the electrode stack in the stacking direction and/or between the positive electrode tab and the packaging material at at least one of both ends of the electrode stack in the stacking direction.

### Explanation of Reference Numerals

1, 10 nonaqueous electrolyte battery
2, 12 packaging material
3, 13 negative electrode tab
3a, 13a negative electrode tab convergence part
4, 14 negative electrode tab lead
5 tab fixing member
11 electrode stack
16 positive electrode tab
16a positive electrode tab convergence part
17 positive electrode tab lead

What is claimed is:

1. A nonaqueous electrolyte battery comprising: a packaging material; and an electrode stack housed in the packaging material, the electrode stack comprising a plurality of positive electrodes and a plurality of negative electrodes stacked via an electrolyte,
the nonaqueous electrolyte battery further comprising a positive electrode tab lead and a negative electrode tab lead protruding from the packaging material,
a plurality of positive electrode tabs extending from the positive electrodes, end parts of the plurality of positive electrode tabs converging to form a positive electrode tab convergence part, and the positive electrode tab convergence part being connected to the positive electrode tab lead,
a plurality of negative electrode tabs extending from the negative electrodes, end parts of the plurality of negative electrode tabs converging to form a negative electrode tab convergence part, and the negative electrode tab convergence part being connected to the negative electrode tab lead, and
a tab fixing member for fixing tabs being disposed between at least one pair of the negative electrode tabs adjacent to each other and/or between at least one pair of the positive electrode tabs adjacent to each other.

2. The nonaqueous electrolyte battery according to claim 1, wherein a plurality of the tab fixing members are arranged side by side in a plane direction of the electrode stack.

3. The nonaqueous electrolyte battery according to claim 1, wherein the tab fixing member is disposed between the negative electrode tabs at each end of the electrode stack in a stacking direction and/or between the positive electrode tabs at each end of the electrode stack in the stacking direction.

4. The nonaqueous electrolyte battery according to claim 1, wherein the tab fixing member is disposed between all of the negative electrode tabs adjacent to each other and/or between all of the positive electrode tabs adjacent to each other.

5. The nonaqueous electrolyte battery according to claim 1, wherein the tab fixing member is further disposed between a negative electrode tab and the packaging material at at least one of both ends of the electrode stack in a stacking direction and/or between a positive electrode tab and the packaging material at at least one of both ends of the electrode stack in the stacking direction.

6. The nonaqueous electrolyte battery according to claim 1, wherein the tab fixing member is an insulator.

7. The nonaqueous electrolyte battery according to claim 1, wherein the tab fixing member is frictionally fixed to the negative electrode tabs and/or the positive electrode tabs.

8. The nonaqueous electrolyte battery according to claim 1, wherein the tab fixing member has a curved surface facing and contacting a negative electrode tab and/or a positive electrode tab.

9. The nonaqueous electrolyte battery according to claim 1,
wherein the negative electrode is a lithium metal negative electrode or a silicon negative electrode, and
wherein the tab fixing member is disposed between at least one pair of the negative electrode tabs adjacent to each other.

10. The nonaqueous electrolyte battery according to claim 1, wherein the nonaqueous electrolyte battery is a solid-state battery.
